(19) United States
(12) Patent Application Publication
(10) Pub. No.: US 2024/0328662 A1
(43) Pub. Date: Oct. 3, 2024

(54) APPARATUS TO SUPPORT EXTERNALLY TENSIONED PLIABLE AIR DUCTS

(71) Applicant: RITE-HITE HOLDING CORPORATION, Milwaukee, WI (US)

(72) Inventors: Nicholas L. Kaufmann, Sherrill, IA (US); Kevin J. Gebke, Dubuque, IA (US); Emily C. Stockhausen, Fox Point, WI (US); Blaine M. Schmidt, Dubuque, IA (US)

(21) Appl. No.: 18/621,674

(22) Filed: Mar. 29, 2024

Related U.S. Application Data
(60) Provisional application No. 63/493,122, filed on Mar. 30, 2023.

(51) Int. Cl. F24F 13/02

(52) U.S. Cl. CPC F24F 13/0254; F24F 13/0218

(57) ABSTRACT

Methods, apparatus, systems, and articles of manufacture are disclosed to support externally tensioned pliable air ducts comprising a hoop disposable within an air duct, the air duct having a tubular sidewall made of a pliable material; a first tab protruding from a first point on the hoop, the first tab including a first opening to engage a first support structure located on a first side of the air duct; and a second tab protruding from a second point on the hoop, the second tab including a second opening to engage a second support structure located on a second side of the air duct opposite the first side.

### RELATED APPLICATION

This patent claims the benefit of U.S. Provisional Patent Application No. 63/493,122, which was filed on Mar. 30, 2023. U.S. Provisional Patent Application No. 63/493,122 is incorporated herein by reference in its entirety.

### FIELD OF THE DISCLOSURE

This disclosure relates generally to pliable air ducts, and, more particularly, to apparatus for supporting externally tensioned pliable air ducts.

### BACKGROUND

Ductwork is often used to convey conditioned (e.g., heated, cooled, filtered, humidified, dehumidified, etc.) air discharged from a fan and to distribute the air to a room or other areas within a building. Ducts are typically formed of generally self-supporting sheet metal, such as steel, aluminum, or stainless steel. Some ducts, however, are made of pliable materials, such as fabric or flexible plastic sheeting.

Pliable ducts are often suspended from a horizontal cable or track by way of a series of connectors distributed along the length of the duct. The connectors may include snap-hooks, clips, rings, or other type of connector that can slide along the cable or track. The connectors preferably allow the fabric duct to be readily removed from its cable or track so that the fabric duct can be cleaned.

When a fan or blower forces air through a pliable duct to supply the room with air, the pressure of the forced air tends to inflate the duct. This can cause the duct to expand radially and longitudinally to a generally cylindrical shape. When the ventilating or other conditioning demand of the room is satisfied, the blower is usually turned off, which allows the duct to deflate and, in some cases, retract lengthwise.

### BRIEF DESCRIPTION OF THE DRAWINGS

FIG. 1. is side view of an example air duct assembly constructed in accordance with teachings disclosed herein.

FIG. 2 is a side view similar to FIG. 1 but showing the duct inflated.

FIG. 3 is a cross-sectional view of the example duct of FIGS. 1 and 2 showing an example hoop and tabs constructed in accordance with teachings disclosed herein.

FIG. 4 is a close-up view of one example tab of FIG. 3 constructed in accordance with teachings disclosed herein.

FIG. 5 is a cross-sectional view similar to FIG. 3 but showing another example hoop and tabs constructed in accordance with teachings disclosed herein.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time +/−1 second.

### DETAILED DESCRIPTION

Depending on the structural framework and materials involved, in some cases, when a pliable duct is installed and tensioned, supporting structures (e.g., tensioned cables) may damage or interfere with a pliable tubular sidewall of the duct. If the supporting structures are installed imperfectly or do not meet a tolerance threshold (e.g., a degree of parallelism between two supporting members), inflation and operation of the pliable duct can cause accelerated wear in the sidewall.

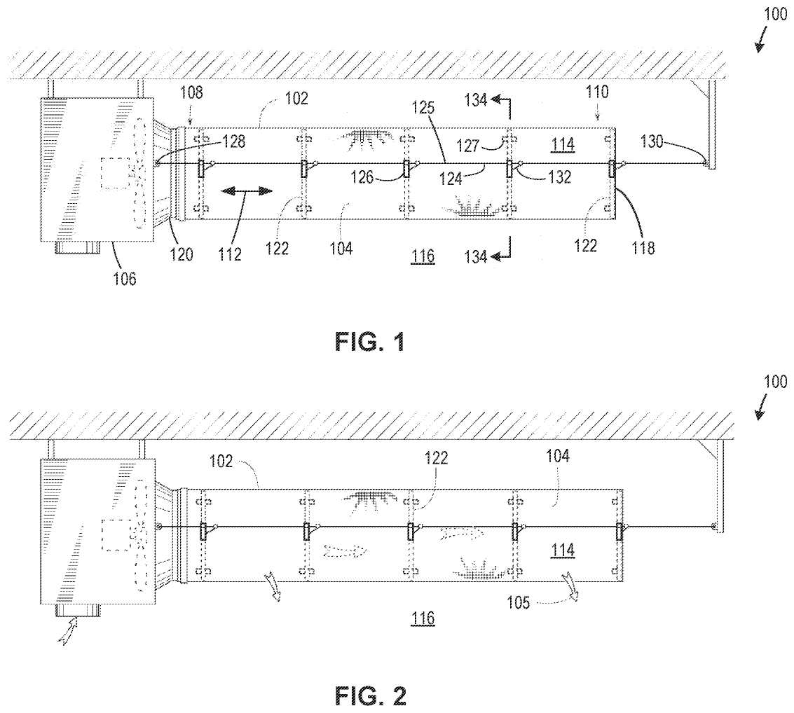

FIGS. 1-5 show various views of an example air duct assembly 100 comprising an air duct 102 with a tubular sidewall 104 made of pliable material. In the illustrated example, the air duct 102 is installed to convey air 105 discharged from a blower 106 to a room or other areas of a building. Turning the blower 106 on and off, as needed, repeatedly places the duct selectively in an inflated state (e.g., when the air 105 is being blown through the air duct 102 as in FIG. 2) and a deflated state (e.g., when the air 105 is not being blown through the air duct 102 as in FIG. 1). To provide the example air duct 102 with an inflated appearance even when deflated, the example duct includes means for holding a deflated duct's pliable sidewall in a generally inflated shape.

As used herein, the term “pliable material” refers to a material that can be readily folded over onto itself and later unfolded and restored to its original shape without appreciable damage to the material. Fabric is one example of a pliable material, and sheet metal is an example of a material that is not pliable. As used herein, the term “inflated state” refers to an air duct that is pressurized, and the term “deflated state” refers to an air duct that is not pressurized. According to these definitions, the interior of the duct is at least slightly more expanded (longitudinally or radially) in the inflated state as compared to the deflated state.

In the example shown in FIGS. 1 and 2, the air duct 102 includes an upstream end 108 proximate to the blower 106 and a downstream end 110 distal to the blower 106. As used herein, the terms “upstream” and “downstream” are used with respect to the air 105 flowing in a longitudinal direction 112 within an interior 114 of the air duct 102. More particularly, the air 105 flows from an upstream end of the duct 102 toward a downstream end of the duct 102. In some examples, porosity and/or other openings in the sidewall 104 allow the air 105 within the duct's interior 114 to disperse into an external area 116 outside of the duct 102. In some examples, an end cap 118 blocks off the duct's downstream end 110. In some examples, the end cap 118 is made of a material similar to that of the sidewall 104. In some examples, the end cap 118 is not included, and a hoop 122 is installed at the downstream end 110 of the air duct 102 to allow the air 105 to flow unobstructed in the longitudinal direction 112.

In the illustrated example, the duct's upstream end 108 is supported by a discharge flange and/or blower flange 120 of the blower 106, and the rest of the duct 102 is supported by various support structures. Examples of such support structures include one or more hoops 122 attached to a surface of the duct's interior 114, one or more elongate external support members 124 extending along an exterior of the air duct 102, and tabs 126 to couple the one or more elongate support members 124 to the hoops 122. The example hoops 122 radially support the sidewall 104 of the duct 102. In some examples, the hoops 122 can be attached to (e.g., held against) the surface of the interior 114 using one or more hoop fasteners 127. The term “hoop fastener,” as used herein, refers to any structure at least partially disposed within the interior of a pliable-wall air duct, wherein the structure captures and holds an internal hoop at a desired position within the duct. As a specific example, a hoop fastener 127 can correspond to a strip of material (the same as or different than the pliable material of the sidewall 104 of the duct 102) that defines a loop that wraps around a rim of the hoop within the duct 102 and is affixed to an interior surface of the sidewall 104 on either side of the rim of the hoop 122 to hold the hoop 122 in place adjacent the sidewall 104.

The term “external support member,” as used herein, refers to any structure and/or framework positioned outside of the air duct 102 that carries at least some weight of the sidewall 104. In some examples, the external support member 124 extends in the longitudinal direction 112 along a length of the air duct 102 (e.g., from a first longitudinal end of the air duct 102 towards a second longitudinal end of the air duct 102). Further, the external support member 124 can extend along the length of the air duct 102 at a height that is greater than a lowermost surface of the sidewall 104. In some examples, the support member 124 is paired with another support member 124 not shown in FIG. 1 or 2, which is on the opposite side of the duct 102. In some examples, the second support member 124 is less than (or greater than) approximately 180 degrees from the first support member 124 relative to a central axis of the air duct 102. For example, a location of the second support member 124 on a first side of the air duct 102 mirrors/opposes a location of the first support member 124 on a second side of the air duct 102 (e.g., at the 10 o′clock and 2 o′clock positions, at the 8 o′clock and the 4 o′clock positions, etc.). In some examples, the second support member 124 is approximately 180 degrees from the first support member 124 relative to the central axis of the air duct 102. Examples of the external support member 124 include a cable 125, a wire, a strap, a chain, a bar, a rod, a track, a beam, a ceiling, and various combinations thereof. In examples disclosed herein, the term “approximately 180 degrees” refers to spacing between two points or objects that are 180 degrees apart within some degree of acceptable tolerance (e.g., within +/−five degree) along a circumference of a circular object (e.g., the hoop 122 and/or a section of the sidewall 104 of the air duct 102).

The example duct assembly 100 illustrated in FIGS. 1 and 2 can be referred to as a dual-cable assembly in which the external support member(s) 124 correspond to a pair of cables 125. The cables 125 are installed between two anchor points 128, 130 in the environment surrounding the air duct 102. The cables 125 extend along the duct 102 and/or are radially spaced about a central axis of the duct 102 (e.g., at a 3 o′clock position and a 9 o′clock position). A plurality of hoops 122 are distributed along the length of the duct 102. In some examples, the cables 125 are threaded or inserted into the tabs 126 via one or more slots or holes in the tabs 126. One or more clamps 132 (e.g., external cable fasteners) are included in the air duct assembly 100 to couple the hoops 122 and/or the sidewall 104 of the duct 102 to the cables 125. The tabs 126 protrude outward from the hoops 122 and are included to physically space the cables 125 from the sidewall 104 via reactionary forces. The example cables 125 are tightened between the first anchor point 128 and the second anchor point 130 (e.g., using a tensioning tool) to support at least some of weight of the air duct 102 as the weight is transferred to the cables 125 via the tabs 126 and/or the clamps 132. Further, due to the clamps 132 coupling the hoops 122 and/or the sidewall 104 to the cables 125, as the cables 125 are tensioned, the clamps 132 pull the sidewall 104 taut in the longitudinal direction 112 so that the full length of the sidewall 104 tends to follow the shape of an outer diameter of the hoop 122, regardless of whether the duct 102 is inflated or deflated.

In some examples, installation of the air duct assembly 100 begins with attachment of the cables 125 extending between the two anchor points 128, 130. The tabs 126 (extending from the hoops 122 through the sidewall 104 of the duct) are then installed on the cables 125. In some examples, the cables 125 are initially fixed to the anchor points 128, 130 with some amount of slack to facilitate attachment of the tabs 126. In such examples, the cables 125 are run (e.g., extended) through the holes or slots in the tabs 126 to maintain separation between the sidewall 104 and the cables 125 so as to reduce wear on the sidewall 104. The clamps 132 can then be secured to the cables 125, and the cables 125 can be tensioned (e.g., using a tensioning tool) in the longitudinal direction 112 to pull the cables 125 taut, thereby placing the air duct 102 in tension (based on the clamps 132 coupled to the cables 125). Alternatively, the cables 125 can be tensioned in the longitudinal direction 112 before the clamps 132 are coupled to the cables 125. In such examples, the air duct 102 is tensioned independent of the cables 125 and then secured in its taut state by attaching the clamps 132 to the tensioned cables 125. In such examples, the tabs 126 can be coupled to the cables 125 either before or after the cables 125 are tensioned.

In the illustrated example of FIGS. 1 and 2, each of the hoops 122 includes corresponding tabs 126 and corresponding clamps 132. However, in some examples, one or more of the hoops 122 may not have any tabs 126 but are nevertheless coupled to the cables 125 via corresponding clamps 132. Additionally or alternatively, in some examples, one or more of the hoops 122 may not be associated with any clamps but are nevertheless coupled to the cables 125 via corresponding tabs 126. Further, in some examples, one or more of the hoops 122 does not include any tabs 126 and is not associated with any clamps 132. The tabs 126 may be radially spaced and/or longitudinally spaced about the duct 102.

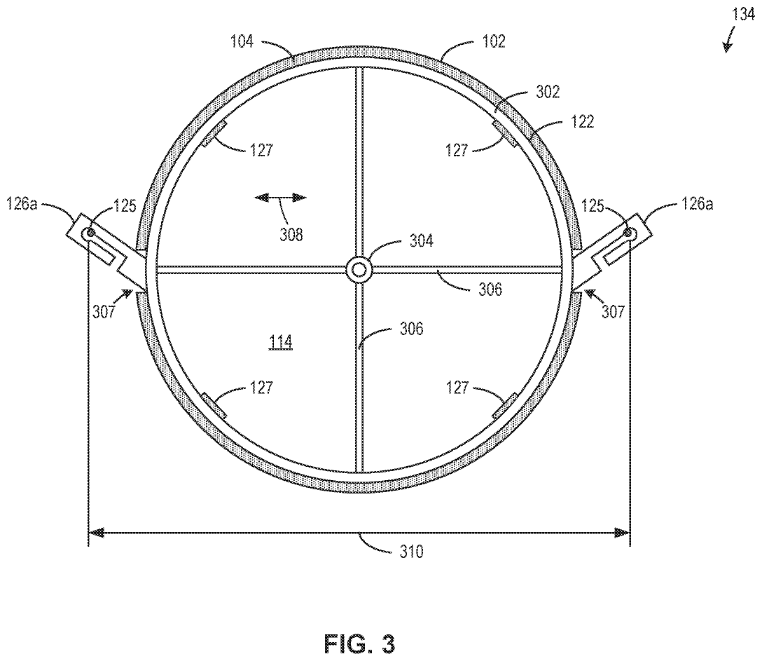

The hoop 122 is any structure that helps hold the sidewall 104 expanded at least when the blower 106 is de-energized. In the examples illustrated in FIGS. 3-5, the hoop 122 includes an outer rim 302, a central hub 304, and one or more spokes 306 that helps maintain the hoop's circular or other predetermined shape. In some examples, the hoop 122 includes only the outer rim 302 without the spokes 306 and without the hub 304. In some examples, the hoops 122 include the one or more spokes 306 but omit the central hub 304. In some examples, the hoop 122 is made of metal, such as steel or aluminum. As shown in FIGS. 3-5, the tabs 126 are positioned to extend outward from the hoop 122 in a plane defined by the outer rim 302. As a result, when the hoops 122 are installed within the duct 102, the tabs 126 extend through example respective openings 307 in the sidewall 104 in a direction that is approximately perpendicular to the duct 102 in the longitudinal direction 112. In other examples, the tabs 126 extend at a non-parallel angle relative to the plane of the outer rim 302 such that the tabs 126 are angled either toward the upstream end 108 or the downstream end 110 of the duct 102. In some examples, the tabs 126 are manually clamped to the cables 125 to couple the hoops 122 to the cables 125. Such a configuration enables the tabs 126 to support the weight of the duct 102 in a vertical direction, hold the duct 102 taut in the longitudinal direction 112, and/or inhibit the cables 125 from touching the sidewall 104.

FIG. 3 is a first illustrative example of one of the hoops 122 disposed (e.g., disposable) within the air duct 102 of from a cross-sectional perspective 134 of FIG. 1. As shown in the illustrated example, two slotted tabs 126a (e.g., a first tab and a second tab, a first branch and a second branch, a first support arm and a second support arm, etc.) are coupled (e.g., rigidly coupled, pivotally coupled, etc.) to the hoop 122 to space the two cables 125 from the sidewall 104 and/or to hold the hoops 122 in their proper position within the duct 102. In this example, the proper positioning is with respect to the hoop's axial location along the longitudinal direction 112, the hoop's perpendicularity relative to the longitudinal direction 112, the hoop's radial position about a central axis of the duct 102, and/or the hoop's lateral position relative to the cables 125 (a latitudinal direction 308). As shown in the illustrative example, the respective openings 307 are included in the tubular sidewall 104 to permit extension of the tabs 126a from the hoop 122 to the cables 125. The openings can be slits, holes, apertures, and/or windows of any shape (e.g., circular, rectangular, linear, etc.) that are constructed to withstand the tensioning of the air duct 102 without unwanted tearing or deformation of the sidewall 104 or the openings 307. In some examples, the respective openings 307 can be selectively opened and closed via zippers, hook-and-loop fasteners, and/or using any other suitable mechanism.

As mentioned above in connection with FIGS. 1 and 2, hoop fasteners 127 are attached to the sidewall 104 on either side of the hoop 122 and extend over the hoop 122, as shown in FIG. 3, to hold the hoop 122 in the proper position relative to the longitudinal direction 112 and the latitudinal direction 308. The example hoop fasteners 127 can correspond to one or more pieces of pliable and/or rigid material (e.g., same as or different than the pliable material of the sidewall 104 of the duct 102) that envelopes a portion of the outer rim 302 and is affixed to the interior surface of the sidewall 104 on either side of the hoop 122. In some examples, the hoop fasteners 127 are permanently affixed to the interior surface of the sidewall 104 (e.g., incapable of being removed without damaging the sidewall 104 and/or the hoop fasteners 127) via threading and/or adhesives. In some other examples, the hoop fasteners 127 are selectively attachable and/or detachable from the sidewall 104 on one or both sides of the hoop 122 via snaps, clips, ties, hook-and-loop fasteners, and/or some other mechanism(s) that provide enough strength to couple the hoop fasteners 127 to the sidewall 104 during operation of the air duct 102.

In the illustrated example, the slotted tabs 126a are made of a rigid material (e.g., aluminum, steel, carbon fiber, etc.) fixed to the hoop's outer rim 302. Other examples of the slotted tabs 126a are made of combinations of different types of materials, including metals, composites, and/or acetal plastics. Some example slotted tabs 126a include other materials that provide a similar stiffness to keep the sidewall 104 separated from the support member 124 and to prevent interference during tensioning and operation of the duct 102. In other words, in some examples, the slotted tabs 126a are rigid and/or stiff and protrude outward from the hoop 122 to maintain a separation between the cables 125 and the sidewall 104 of the air duct 102. In some examples, the slotted tabs 126a are attached to the hoop 122 by means for fastening, such as bolts, welds, and/or interference fits. In some examples, the tabs 126a are selectively attachable and detachable from the hoop 122. In other examples, the tabs 126a are permanently affixed to the hoops 122 (e.g., incapable of being removed without damaging the hoop 122, the tabs 126a and/or the joint therebetween). In some examples, the slotted tabs 126a and the hoop 122 (e.g., the outer rim 302) are made from the same integrated part, such as from the same piece of punched, stamped, and/or sheared sheet metal or from the same die cast mold. As such, the slotted tabs 126a and the hoop 122 may be non-separably connected. In some examples, as shown in FIG. 3, first and second tabs 126a are attached to the hoop 122 and protrude from respective first and second diametrically opposed points (e.g., 180 degrees apart) on the outer rim 302. In other words, the first tab 126a is positioned at a first circumferential location on the hoop 122 and the second tab 126b is positioned at a second circumferential location on the hoop 122 different from the first circumferential location. In FIG. 3, the first circumferential location of the first tab 126a is positioned on a first side of the hoop 122 and the second circumferential location of the second tab 126a is positioned on a second side of the hoop 122 opposing the first side. Further, the first and second tabs 126a can extend away from a center of the hoop 122. As shown in FIG. 3, in some examples, the first and second tabs 126a extend away from the center of the hoop 122 at an angle relative to a direction extending directly radially outward from the center. In the illustrated example, the tabs 126a have a generally rectangular shape. However, the tabs 126a may have any other shape.

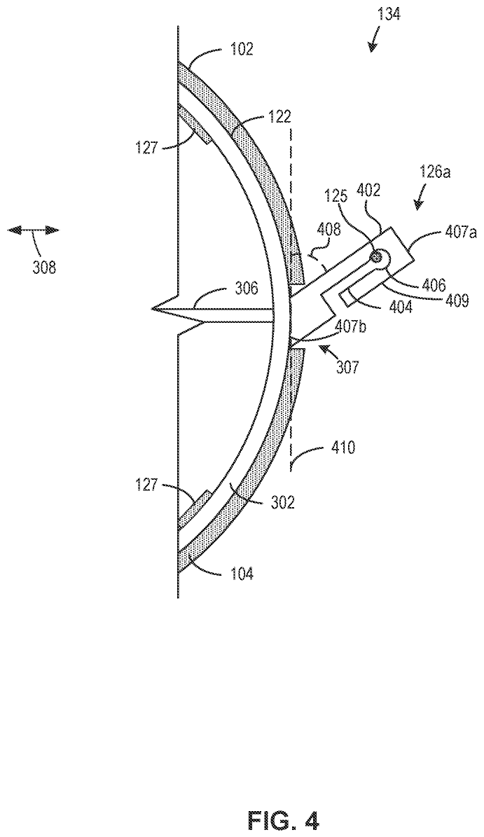

FIG. 4 shows a close-up view of the slotted tab 126a of FIG. 3 comprising a body 402, an elongate slot 404, and a hole 406 that together connect the hoop 122 to one of the cables 125 (one example of the overhead support member 124). In some examples, the slotted tab 126a includes the hole 406 to engage and/or retain one of the cables 125. Put differently, the slotted tab 126a is attachable to one of the cables 125 using the hole 406. In this example, the one of the cables 125 is retained adjacent a first end 407a (distal to the hoop) of the slotted tab 126a. As such, the one of the cables 125 is positioned between the first end 407a of the slotted tab 126a and the sidewall 104. Additionally, the hole 406 is positioned between the first end 407a of the slotted tab 126a and the hoop 122. In the illustrated example, the elongate slot 404 extends between the first end 407a and a second end 407b (proximate to the hoop 122) of the slotted tab 126a. As shown in the illustrated example, an end of the elongate slot 404 is open at and/or extends to an edge 409 of the slotted tab 126. In this example, the edge 409 of the slotted tab 126a extends between the first end 407a of the slotted tab 126a and the hoop 122. Further, the edge 409 of the slotted tab 126a faces downward when the hoop 122 is supported by the one of the cables 125 via the slotted tab 126a.

In some examples, the width of the slot 404 and/or the size of the hole 406 are designed according to the thickness or cross-sectional diameter of the cables 125. In some examples, the width of the slot 404 is dimensioned to be at least slightly larger than the thickness of the cable 125 (e.g., at least 0.005 inches larger) to enable an installer of the duct assembly 100 to insert the cable 125 into the hole 406 through the slot 404. In other examples, the width of the slot 404 may be equal to or less than the thickness of the cables 125. The slot 404 may nevertheless enable the cable 125 to pass therethrough based on elastic deformation of the tabs 126a.

In this example, the elongate slot 404 is open at one end (e.g., extends to an edge of the tab 126a) and extends to the hole 406 at the other end to define a path to guide the cables 125 to the holes. The particular shape of the path defined by the elongate slot 404 can be any suitable shape and may include one or more straight sections (as shown), may include curved sections, or a combination thereof. In this example, the open end of the slot 404 is on a bottom edge of the tab 126a. However, in other examples, the open end of the slot 404 is on a top edge of the tab 126a. In other examples, the open end of the slot 404 is on the distal edge of the tab 126a farthest from the hoop 122.

In some examples, the elongate slot 404 is constructed to extend away from the hole 406 at a downward angle such that the weight of the hoop 122 (and duct 102) will cause the cables 125 to remain within the hole 406 at the end of the slot 404. In the illustrated example, the hole 406 is circular. However, in other examples, the hole 406 can be any other shape. In some examples, as shown, the hole 406 has a diameter that is greater than a width of the slot 404. In other examples, the hole 406 is the same size as the slot 404 or, alternatively, the hole 406 is omitted such that the cable 125 is positioned at the end of the elongate slot 404.

In some examples, installation of the duct assembly 100 includes tensioning the cables 125 in the longitudinal direction 112 following insertion of the cables 125 into the hole 406 via the slot 404. In some examples, the length of the tabs 126a extending outward from the hoop 122 and the corresponding location of the holes 406 within the tabs 126a are dimensioned to be at a distance 310 that is larger than the expected spacing of the two cables 125 once tensioned between corresponding anchor points 128, 130. In such examples, the cables 125 apply a reactionary force in the latitudinal direction 308 on an inner wall of the holes 406, which produces a frictional force between the cables 125 and the inner wall. In some examples, the combination of the reactionary and frictional forces is sufficient to prevent the cables 125 from sliding back through the angled slot 404 during installation or operation. In some examples, the hoop 122, tabs 126a and holes 406 therein are designed so that the distance 310 is smaller than the expected spacing of the two cables 125 so that the cables 125 are urged against outer walls of the holes. In other examples, the distance 310 is designed to be the same as the expected spacing of the cables 125. In such examples, relatively little frictional forces are created between the tabs 126a and the cables 125. In some examples, when the cables 125 are fit into the holes 406 and then tensioned, the installer may elastically or plastically clamp or deform the tabs 126a around the cable 125 to fix the hoop 122 in place along the longitudinal direction 112. Additionally or alternatively, the example slotted tab 126a can include a hinge clamp (e.g., a wingnut clamp), a latch clamp (e.g., an adjustable toggle latch clamp), or another means for gripping the cables 125. In such examples, the means for gripping the cables 125 is accomplished by the clamps 132 discussed above in connection with FIGS. 1 and 2. In some examples, the clamps 132 are attached to the hoop 122 independent of the tabs 126a. In other examples, the clamps 132 are attached to the tabs 126a.

In the illustrated examples of FIG. 4, the slotted tab 126a is attached to the outer rim 302 of the hoop 122 at an angle 408 (e.g., a non-perpendicular angle, etc.) relative to a reference line 410. The reference line 410 is tangential to a right-most edge of the outer rim 302 in the latitudinal direction 308. As previously mentioned, the air duct assembly 100 is tensioned during installation, and the cable 125 tends to draw inward (in the latitudinal direction 308) toward the sidewall 104 due to the tensioning. The slotted tab 126a is positioned at the angle 408 shown in FIG. 4 to account for a force the cable 125 applies to the slotted tab 126a when tensioned. The angle 408 of the slotted tab 126a can be a value approximately between zero degrees and ninety degrees. When the slotted tab 126a is oriented as shown in FIG. 4 (e.g., 45 degrees, etc.), the cable 125 applies a force in the latitudinal direction 308 (toward the hoop 122) that may partially or fully act on the hole 406. When the slotted tab 126a is perpendicular to the reference line 410, the tensioned cable 125 applies a force in the latitudinal direction 308 (toward the hoop 122) that may partially or fully act on the means for gripping the cable 125. In some examples, the slotted tabs 126a are positioned at the angle 408 relative to respective reference lines (e.g., reference line 410, etc.) tangential to the hoop 122, such that the angles (e.g., angle 408, etc.) corresponding to the respective slotted tabs 126a can be the same or different values.

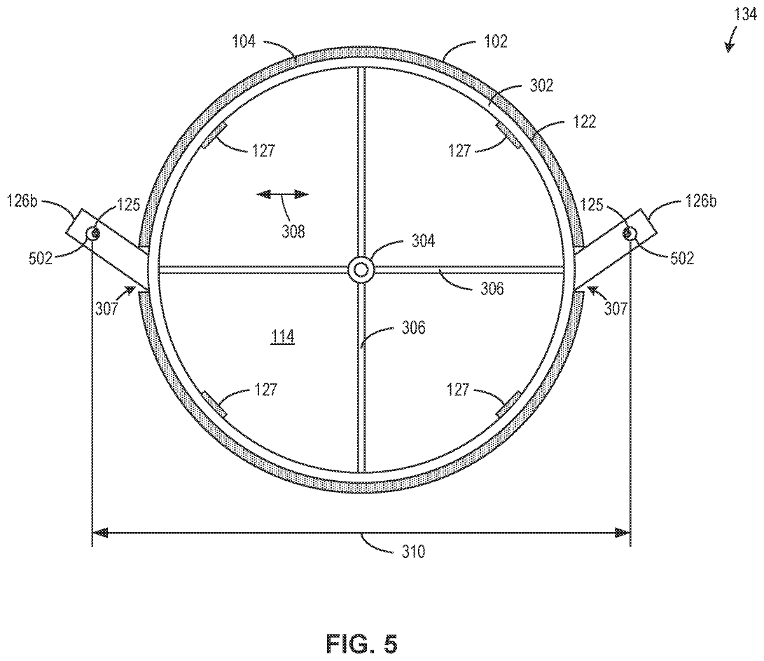

FIG. 5 is a second illustrative example of the hoop 122 disposed within the air duct 102 from the cross-sectional perspective 134 of FIGS. 1 and 2. Similar structures and components in FIG. 5 shown and described above in connection with FIGS. 3 and 4 are identified by the same reference numbers in FIG. 5. The discussion of such structures and components provided above in connection with FIGS. 3 and 4 applies similarly to FIG. 5. The hoop 122 illustrated in FIG. 5 includes two example holed tabs 126b (e.g., a first tab and a second tab) attached to first and second sides (e.g., the 3 o′clock and 9 o′clock positions) of the outer rim 302. The holed tabs 126b include holes 502 that are provided to maintain the cables 125 spaced apart from the sidewall 104 and/or to fix the hoops 122 in their proper position within the duct 102. In the illustrated example of FIG. 5, the holed tabs 126b are made of rigid material(s) (e.g., aluminum, steel, carbon fiber, etc.) fixed to the hoop's outer rim 302. Other examples of the holed tabs 126b are made of combinations of different types of materials, including metals, composites, and/or acetal plastics. Some example holed tabs 126b include other materials that provide a similar stiffness to keep the sidewall 104 separated from the support member 124 and to prevent interference during tensioning and operation of the duct 102. In some examples, the holed tabs 126b are attached to the hoop 122 by the means for fastening described above in connection with FIGS. 3 and 4. In some examples, the holed tabs 126b and the hoop 122 (e.g., the outer rim 302) are made from the same integrated part, such as punched, stamped, and/or sheared from the same piece of sheet metal or cast from the same die mold.

When the air duct assembly 100 includes the tabs 126b as illustrated in FIG. 5, the cables 125 are first thread through the holes 502 prior to attaching the cables 125 at the anchor points 128, 130. In this example, an installation time of the air duct assembly 100 may be longer (e.g., relative to when the slotted tabs 126a are included), but the holed tabs 126b are less complex to manufacture than the slotted tabs 126a and eliminate the risk of the cables 125 slipping out through the slot 404 in the illustrated example of FIGS. 3 and 4. If the cables 125 were to slip out of the slotted tabs 126a, then sidewall 104 and/or the air duct 102 could incur some damage(s), such as ripping, tearing, fraying, bending, fracturing, and/or structural failure.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

From the foregoing, it will be appreciated that example systems, methods, apparatus, and articles of manufacture have been disclosed that support an externally tensioned pliable air duct. Disclosed systems, methods, apparatus, and articles of manufacture improve the efficiency of using a pliable air duct by spacing support members (such as cables) away from a sidewall of the air duct and preventing the support members from interfering with and/or damaging the sidewall. Reducing contact between the support members and the sidewall of the pliable air duct can reduce wear on the air duct, thereby increasing the useful life of such an air duct. Disclosed systems, methods, apparatus, and articles of manufacture are accordingly directed to one or more improvement(s) in the operation of a mechanical device.

Example 1 includes an apparatus comprising a hoop disposable within an air duct, the air duct having a tubular sidewall made of a pliable material, a first tab protruding from a first point on the hoop, the first tab including a first opening to engage a first support structure located on a first side of the air duct, and a second tab protruding from a second point on the hoop, the second tab including a second opening to engage a second support structure located on a second side of the air duct opposite the first side.

Example 2 includes the apparatus of example 1, wherein the first point is circumferentially spaced apart from the second point along an outer rim of the hoop, the first point on an opposite side of the air duct from the second point.

Example 3 includes the apparatus of any one of examples 1 or 2, wherein the first and second support structures include first and second cables, the first and second tabs rigidly coupled to the hoop to separate the first and second cables from the tubular sidewall when the air duct is in an inflated state.

Example 4 includes the apparatus of example 3, wherein the first opening in the first tab includes a slot extending between a first end of the slot and a second end of the slot, the first end being open at an edge of the first tab, the first cable to be retained proximate the second end.

Example 5 includes the apparatus of example 4, wherein the first opening includes a hole at the second end of the slot, the hole being larger than a width of the slot.

Example 6 includes the apparatus of any one of examples 1-5, wherein the first tab and the second tab protrude through respective openings in the tubular sidewall.

Example 7 includes the apparatus of any one of examples 1-6, wherein the first tab and the second tab are positioned at an angle relative to reference lines tangential to the hoop at the respective first and second points, the angle being approximately between zero degrees and ninety degrees.

Example 8 includes an air duct system comprising an air duct including a tubular sidewall that is pliable, and a hoop disposable within the air duct, the hoop including a first branch positioned at a first circumferential location on the hoop, the first branch extending away from a center of the hoop, the first branch including a first aperture, the first branch attachable to a first portion of an external framework using the first aperture, and a second branch positioned at a second circumferential location on the hoop different from the first circumferential location, the second branch extending away from the center of the hoop, the second branch including a second aperture, the second branch attachable to a second portion of the external framework using the second aperture.

Example 9 includes the air duct system of example 8, wherein the hoop, the first branch, and the second branch are non-separably connected.

Example 10 includes the air duct system of any one of examples 8 or 9, wherein the first and second apertures retain the first and second portions of the framework, respectively.

Example 11 includes the air duct system of any one of examples 8-10, wherein the first circumferential location is positioned on a first side of the hoop and the second circumferential location is positioned on a second side of the hoop, the first side opposing the second side.

Example 12 includes the air duct system of any one of examples 8-11, wherein the first aperture is positioned between a first end of the first branch and the hoop, the second aperture is positioned between a second end of the second branch and the hoop, the first portion of the framework is to be positioned between the first end of the first branch and the tubular sidewall, and the second portion of the framework is to be positioned between the second end of the second branch and the tubular sidewall.

Example 13 includes the air duct system of example 12, wherein a first edge of the first branch extends between the first end of the first branch and the hoop, the first aperture extends to the first edge, a second edge of the second branch extends between the second end of the second branch and the hoop, and the second aperture extends to the second edge.

Example 14 includes the air duct system of example 13, wherein the first and second edges face downward when the hoop is supported by the framework via the first and second branches.

Example 15 includes the air duct system of any one of examples 8-14, wherein the first portion of the framework is a first cable and the second portion of the framework is a second cable.

Example 16 includes the air duct system of example 15, wherein the first cable is to extend through the first aperture, and the second cable is to extend through the second aperture.

Example 17 includes the air duct system of example 16, further including the first and second cables, the first and second cables to extend from a first longitudinal end of the air duct towards a second longitudinal end of the air duct.

Example 18 includes an air duct system comprising an air duct including a pliable tubular wall, a hoop disposable within the air duct to radially support the tubular wall, a first support arm extending outward from the hoop through the tubular wall, and a second support arm extending outward from the hoop through the tubular wall, the first and second support arms to attach to respective first and second external support structures on respective first and second sides of the air duct, the first and second support arms being rigid to maintain a separation between the first and second external support structures and the tubular wall of the air duct.

Example 19 includes the air duct system of example 18, wherein the first support arm includes a first hole, the first external support structure to extend through the first hole, the second support arm including a second hole, the second external support structure to extend through the second hole.

Example 20 includes the air duct system of example 19, wherein the first external support structure and the second external support structure are to be a first distance apart prior to being positioned within the respective first and second holes, the first and second holes a second distance apart, the second distance greater than the first distance.

Example 21 includes the air duct system of example 20, wherein the first external support structure is a first cable, the second external support structure is a second cable, and the first and second cables are to be held in tension.

Example 22 includes the air duct system of any one of examples 20 or 21, wherein the first external support structure is to contact an inner wall of the first hole and the second external support structure is to contact an inner wall of the second hole.

The following claims are hereby incorporated into this Detailed Description by this reference. Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus comprising:
a hoop disposable within an air duct, the air duct having a tubular sidewall made of a pliable material;
a first tab protruding from a first point on the hoop, the first tab including a first opening to engage a first support structure located on a first side of the air duct; and
a second tab protruding from a second point on the hoop, the second tab including a second opening to engage a second support structure located on a second side of the air duct opposite the first side.

2. The apparatus of claim 1, wherein the first point is circumferentially spaced apart from the second point along an outer rim of the hoop, the first point on an opposite side of the air duct from the second point.

3. The apparatus of claim 1, wherein the first and second support structures include first and second cables, the first and second tabs rigidly coupled to the hoop to separate the first and second cables from the tubular sidewall when the air duct is in an inflated state.

4. The apparatus of claim 3, wherein the first opening in the first tab includes a slot extending between a first end of the slot and a second end of the slot, the first end being open at an edge of the first tab, the first cable to be retained proximate the second end.

5. The apparatus of claim 4, wherein the first opening includes a hole at the second end of the slot, the hole being larger than a width of the slot.

6. The apparatus of claim 1, wherein the first tab and the second tab protrude through respective openings in the tubular sidewall.

7. The apparatus of claim 1, wherein the first tab and the second tab are positioned at an angle relative to reference lines tangential to the hoop at the respective first and second points, the angle being approximately between zero degrees and ninety degrees.

8. An air duct system comprising:
an air duct including a tubular sidewall that is pliable; and
a hoop disposable within the air duct, the hoop including:
a first branch positioned at a first circumferential location on the hoop, the first branch extending away from a center of the hoop, the first branch including a first aperture, the first branch attachable to a first portion of an external framework using the first aperture; and
a second branch positioned at a second circumferential location on the hoop different from the first circumferential location, the second branch extending away from the center of the hoop, the second branch including a second aperture, the second branch attachable to a second portion of the external framework using the second aperture.

9. The air duct system of claim 8, wherein the hoop, the first branch, and the second branch are non-separably connected.

10. The air duct system of claim 8, wherein the first and second apertures retain the first and second portions of the framework, respectively.

11. The air duct system of claim 8, wherein the first circumferential location is positioned on a first side of the hoop and the second circumferential location is positioned on a second side of the hoop, the first side opposing the second side.

12. The air duct system of claim 8, wherein the first aperture is positioned between a first end of the first branch and the hoop, the second aperture is positioned between a second end of the second branch and the hoop, the first portion of the framework is to be positioned between the first end of the first branch and the tubular sidewall, and the second portion of the framework is to be positioned between the second end of the second branch and the tubular sidewall.

13. The air duct system of claim 12, wherein a first edge of the first branch extends between the first end of the first branch and the hoop, the first aperture extends to the first edge, a second edge of the second branch extends between the second end of the second branch and the hoop, and the second aperture extends to the second edge.

14. The air duct system of claim 13, wherein the first and second edges face downward when the hoop is supported by the framework via the first and second branches.

15. The air duct system of claim 8, wherein the first portion of the framework is a first cable and the second portion of the framework is a second cable.

16. The air duct system of claim 15, wherein the first cable is to extend through the first aperture, and the second cable is to extend through the second aperture.

17. The air duct system of claim 16, further including the first and second cables, the first and second cables to extend from a first longitudinal end of the air duct towards a second longitudinal end of the air duct.

18. An air duct system comprising:
an air duct including a pliable tubular wall;
a hoop disposable within the air duct to radially support the tubular wall;
a first support arm extending outward from the hoop through the tubular wall; and
a second support arm extending outward from the hoop through the tubular wall, the first and second support arms to attach to respective first and second external support structures on respective first and second sides of the air duct, the first and second support arms being rigid to maintain a separation between the first and second external support structures and the tubular wall of the air duct.

19. The air duct system of claim 18, wherein the first support arm includes a first hole, the first external support structure to extend through the first hole, the second support arm including a second hole, the second external support structure to extend through the second hole.

20. The air duct system of claim 19, wherein the first external support structure and the second external support structure are to be a first distance apart prior to being positioned within the respective first and second holes, the first and second holes a second distance apart, the second distance greater than the first distance.

21. The air duct system of claim 20, wherein the first external support structure is a first cable, the second external support structure is a second cable, and the first and second cables are to be held in tension.

22. The air duct system of claim 20, wherein the first external support structure is to contact an inner wall of the first hole and the second external support structure is to contact an inner wall of the second hole.
